(19) United States
(12) Patent Application Publication
(10) Pub. No.: US 2010/0231368 A1
(43) Pub. Date: Sep. 16, 2010

(54) VEHICLE PRESENCE NOTIFICATION APPARATUS

(75) Inventors: Toshiaki Nakayama, Nishikamo-gun (JP); Hitoshi Tanaka, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/720,252

(22) Filed: Mar. 9, 2010

(30) Foreign Application Priority Data
Mar. 11, 2009 (JP) 2009-58456
Mar. 13, 2009 (JP) 2009-61690

(51) Int. Cl. B60Q 1/00

(52) U.S. Cl. 340/425.5

(57) ABSTRACT

A vehicle presence notification apparatus includes a modulating section to modulate an ultrasonic wave functioning as a carrier wave according to an audible sound; and a speaker to generate the audible sound as a notice sound by emitting the modulated ultrasonic wave in the air. As proceeding in the air, the modulated ultrasonic wave is gradually demodulated to thus become the audible sound. The audible sound posterior to the demodulation has a significant directivity like the ultrasonic wave. The notice sound is thus conveyed mainly to a pedestrian who is present in a dangerous area range where a danger needs to be taught. The sense of discomfort due to the notice sound is reduced for a pedestrian, who is not present in the dangerous area region or a person who is inside of another vehicle.

### CROSS REFERENCE TO RELATED APPLICATION

The present application is based on and incorporates herein by reference Japanese Patent Applications No. 2009-58456 filed on Mar. 11, 2009 and No. 2009-61690 field on Mar. 13, 2009.

### FIELD OF THE INVENTION

The present invention relates to a vehicle presence notification apparatus for notifying a person, such as a pedestrian outside a subject vehicle and an occupant in another vehicle, of a presence or approach of the subject vehicle.

### BACKGROUND OF THE INVENTION

[Patent document 1] JP-2006-199110 A

[Patent document 2] JP-H10-201001A

[Patent document 3] JP-2007-182195 A

In a prior art, when a subject vehicle such as an electric vehicle or a hybrid vehicle travels by a motor drive operation, a person outside of the vehicle is made to recognize the presence of the subject vehicle approaching. To that end, a speaker is installed in an outside of the vehicle to thereby produce a notice sound such as a false engine sound and a false running sound for teaching the presence of the vehicle (refer to Patent documents 1, 2).

However, since the notice sound outputted from the speaker is diffused around, it may be heard by a pedestrian (for example, a pedestrian who is present in the back of the vehicle advancing forwardly) who is not present in the dangerous position, or a person who is inside of a vehicle compartment. Thus, the sense of discomfort may be given to other than a pedestrian who is present in the dangerous position. This may be considered as a first issue to be solved.

In contrast, the notice sound such as a false engine sound has a constant sound pressure level and a constant frequency. Even though a pedestrian or the like can thus recognize a vehicle approaching, there is a possibility to be unable to recognize the sense of distance to the vehicle approaching.

That is, the sound pressure level of the back ground noise in the vehicle circumference changes variously depending on the background state such as the daytime or nighttime, or the city or country. Thus, the notice sound may be differently head according to the sound pressure level of the back ground noise. As a result, for example, when the sound pressure level of the back ground noise is greater, the notice sound may be heard smaller, thereby making the sense of distance longer. On the contrary, when the sound pressure level of the back ground noise is smaller, the notice sound may be heard greater, possibly making the sense of distance shorter.

Patent document 3 discloses a vehicle presence notification apparatus, which performs transmission of the radio wave for allowing the recognition by a tactile manner or auditory manner by receiving the transmitted radio wave. In this regard, however, in order to recognize the approach of the vehicle by the foregoing vehicle presence notification apparatus, it is necessary for the vehicle to install a device for transmitting the radio wave. It is further necessary for a pedestrian or the like to have a receiver of the radio wave and a sensory device to operate according to the reception of the radio wave. This is inconvenient in handling.

### SUMMARY OF THE INVENTION

The present invention is made so as to address the above issues. A first object of the present invention is to provide a first technology. The notice sound for teaching a presence of a vehicle approaching is designed to be conveyed to a pedestrian or the like who needs to be notified of the presence of a danger. Thereby, the sense of discomfort due to the notice sound can be reduced for a pedestrian, who is not present in a dangerous place or a person who is inside of a vehicle compartment.

To achieve the above first object, according to a first example of the present invention, a vehicle presence notification apparatus for reporting a presence of a vehicle to an outside of the vehicle is provided as follows. A modulating section is configured to use an ultrasonic wave as a carrier wave and modulate the ultrasonic wave depending on an audible sound. A speaker is configured to emit the modulated ultrasonic wave in air, thereby producing the audible sound as a notice sound.

Under such a configuration, as proceeding in the air, the modulated ultrasonic wave becomes an audible sound. The audible sound posterior to the demodulation has a significant directivity like the ultrasonic wave. Thus, the notice sound can be conveyed mainly to a pedestrian who is present in an area range where a danger needs to be taught. Further, the sense of discomfort due to the notice sound can be reduced for a pedestrian, who is not present in a dangerous place or a person who is inside of a vehicle compartment. In addition, the directivity enables transmission or conveyance of the notice sound toward the area range where the potential danger needs to be taught. Even a compact speaker can properly thus serve as reporting the presence of the subject vehicle. In addition, the ultrasonic wave has a characteristic to easily attenuate; thus, the audible sound posterior to the demodulation has a similar characteristic to easily attenuate. The notice sound does not reach a pedestrian or other vehicles which are separated distantly from the sound origin, i.e., the position of the subject vehicle; thus, the notice sound may not be treated as useless noise.

Furthermore, a second object of the present invention is to provide a vehicle presence notification apparatus which can allow a pedestrian or the like to understand the sense of distance to a subject vehicle, irrespective of sound pressure levels in back ground noises.

To achieve the above second object, according to a second example of the present invention, a vehicle presence notification apparatus for reporting an approach of a vehicle by a notice sound vibrating with a frequency of an audible region is provided as follows. A speaker is configured to put the notice sound on a carrier wave, which vibrates with a frequency of an ultrasonic range, to thereby emit in the air. A carrier frequency switching section is configured to switch the frequency of the carrier wave. The carrier frequency switching section is further configured to (i) store a carrier frequency switching pattern for switching the frequency of the carrier wave among several different frequency values and (ii) switch the frequency of the carrier wave depending on the stored carrier frequency switching pattern.

Under such a configuration, while spreading in the air, the ultrasonic wave emitted from the speaker undergoes a self demodulation to become a notice sound, by the nonlinear characteristic of the air, in which the period required to be compressed is shorter than the period required to be restored from the compressed state. The position, at which the ultrasonic wave emitted from the speaker undergoes the self-demodulation to thereby be heard or audible as a notice sound, is dependent on the frequency of the carrier wave. Also the position, at which the notice sound becomes inaudible after the attenuation, is also dependent on the frequency of the carrier wave. In other words, as the frequency of the carrier wave becomes smaller, the position of the self-modulation becomes more distant from the position of the speaker. It is noted that the notice sound is generated by the self-demodulation. As the frequency of the carrier wave becomes smaller, the position where the notice sound becomes inaudible thus becomes more distant from the position of the speaker.

Accordingly, the frequency of the carrier wave is changed according to the pattern of switching the carrier wave frequencies, thereby allowing the audible state of the notice sound to vary depending on the distance from the speaker. For example, it can be designed that the frequency of the carrier wave is periodically switched between a low value and a high value. in other words, it can be designed that a carrier wave element having a low frequency value and a carrier wave element having a high frequency value can be periodically switched therebetween. Both a notice sound element carried by the carrier wave element having the low frequency value and a notice sound element carried by the carrier wave element having the high frequency value can be heard at a position closer to the position of the speaker; only the notice sound element carried by the carrier wave element having the low frequency value can be heard at a position farther from the position of the speaker. Thus, a pedestrian or the like can recognize the sense of distance to the subject vehicle, irrespective of the sound pressure level in the back ground noise.

### BRIEF DESCRIPTION OF THE DRAWINGS

The above and other objects, features, and advantages of the present invention will become more apparent from the following detailed description made with reference to the accompanying drawings. In the drawings:

FIG. 1A is a block diagram of a vehicle presence notification apparatus according to a first example of a first embodiment of the present invention;

FIG. 1B is a perspective view for illustrating an attachment state of a speaker in FIG. 1A;

FIG. 1C is a side view of a proximity of the speaker in FIG. 1B;

FIG. 2 is a perspective view for illustrating an attachment state to a vehicle with respect to the speaker according to the first example;

FIGS. 3A to 3E are diagrams for explaining a principle of audible sound emission;

FIG. 4 is a view illustrating a speaker and a reflector plate according to a second example of the first embodiment;

FIG. 5 is a block diagram of a vehicle presence notification apparatus according to a first example of a second embodiment of the present invention;

FIG. 6A is a diagram illustrating a pattern of a carrier frequency change of the first example of the first embodiment;

FIG. 6B is a diagram illustrating a self-demodulation of a notice sound at position P1′ according to the first example of the first embodiment;

FIG. 6C is a diagram illustrating a self-demodulation of a notice sound at position P2′ according to the first example of the first embodiment;

FIG. 6D is a diagram illustrating a self-demodulation of a notice sound at position P3′ according to the first example of the first embodiment;

FIG. 7A is a diagram illustrating a notice sound at position P1 according to the first example of the second embodiment;

FIG. 7B is a diagram illustrating a notice sound at position P2 according to the first example of the first embodiment;

FIG. 7C is a diagram illustrating a notice sound at position P3 according to the first example of the first embodiment;

FIG. 8A is a diagram illustrating a pattern of a carrier frequency change according to a second example of the second embodiment;

FIG. 8B is a diagram illustrating a self-demodulation of a notice sound at position P1′ according to the second example of the second embodiment;

FIG. 8C is a diagram illustrating a self-demodulation of a notice sound at position P2′ according to the second example of the second embodiment;

FIG. 8D is a diagram illustrating a self-demodulation of a notice sound at position P3′ according to the second example of the second embodiment;

FIG. 9A is a diagram illustrating a notice sound at position P1 according to the second example of the second embodiment;

FIG. 9B is a diagram illustrating a notice sound at position P2 according to the second example of the second embodiment;

FIG, 9C is a diagram illustrating a notice sound at position P3 according to the second example of the second embodiment;

FIG. 10 is a block diagram of a vehicle presence notification apparatus according to a third example of the second embodiment;

FIG. 11A is a diagram illustrating a notice sound at position P1 according to the third example of the second embodiment;

FIG. 11B is a diagram illustrating a notice sound at position P2 according to the third example of the second embodiment;

FIG. 11C is a diagram illustrating a notice sound at position P3 according to the third example of the second embodiment;

FIG. 12A is a diagram illustrating a pattern of a carrier frequency switching according to a modification example of the second embodiment;

FIG. 12B is a diagram illustrating a notice sound at position P2 according to a modification example of the second embodiment; and

FIG. 12C is a diagram illustrating a notice sound at position P3 according to a modification example of the second embodiment.

### DETAILED DESCRIPTION OF THE PREFERRED EMBODIMENTS

### 1. FIRST EMBODIMENT

A first aspect of a first embodiment of the present invention is directed to a technology to report the presence or existence of a subject vehicle to an outside of the subject vehicle. Such a technology includes a modulation means to use an ultrasonic wave as a carrier wave and modulate the ultrasonic wave depending on an audible sound; and a speaker to generate a notice sound by emitting the modulated ultrasonic wave in the air. In addition, the speaker is provided such that the sound wave is emitted toward the heading direction of the subject vehicle. In the forward direction, i.e., in front, of the speaker, a porosity member or a thin film is arranged. The speaker is installed in a housing. The forward direction of the speaker is blocked by the porosity member or the thin film, whereas another direction other than the forward direction of the speaker is closed by the housing.

In addition, a surrounding wall which surrounds an advancing course of the sound wave is provided in the forward direction of the speaker. The speaker is arranged using a space in a front grille of the vehicle, or a space between a front grille and a hood of the vehicle. The front grille or both the front grille and the hood constitute a portion of the surrounding wall.

A second aspect of the first embodiment is directed to a technology to have a reflector plate to bend an advancing course of a sound wave from a speaker to thereby emit the sound wave towards an advancing direction of the vehicle using the reflector plate. In addition, an opening hole to drain water or dust is provided in the reflector plate which directly collides with a running wind of the vehicle.

### EXAMPLES

### Configuration of First Example

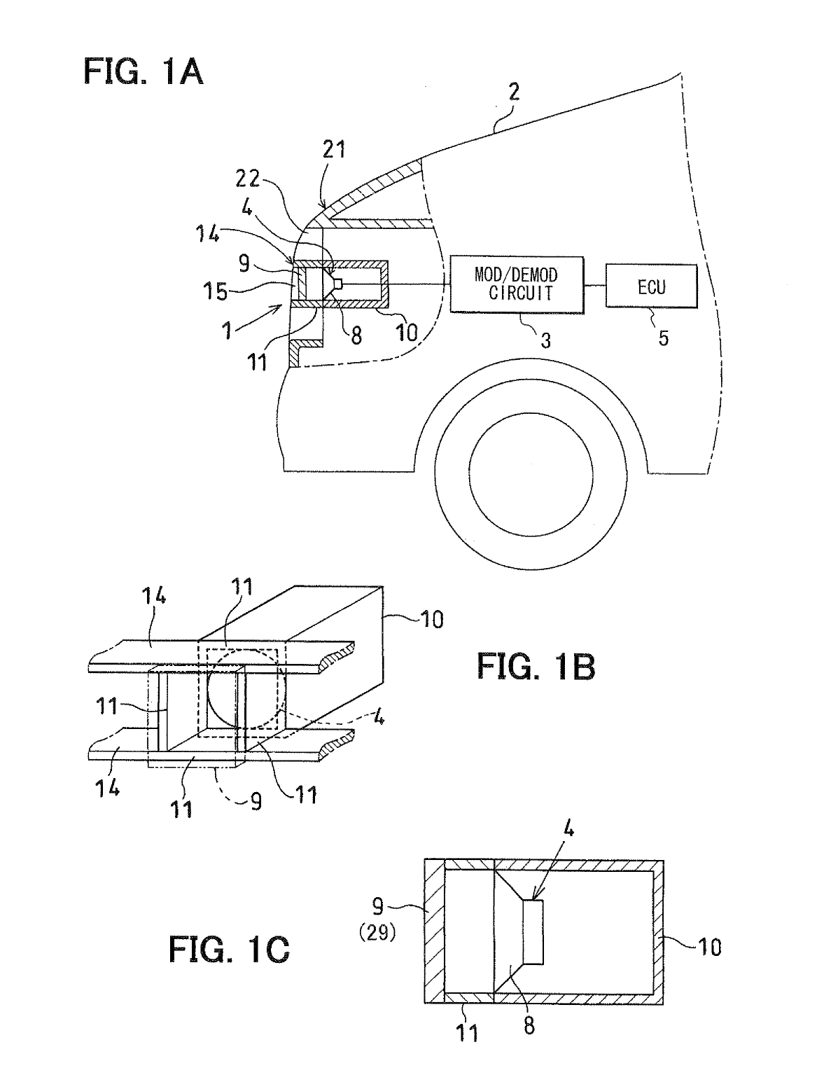

A configuration of a vehicle presence notification apparatus 1 according to a first example of the first embodiment is explained using FIGS. 1A to 1C, FIG. 2, and FIGS. 3A to 3E. The vehicle presence notification apparatus 1 is mounted in a subject vehicle 2 such as an electric vehicle or hybrid vehicle. The vehicle presence notification apparatus 1 generates a notice sound (a false engine sound, a false travel sound, etc.) for notifying or teaching the presence of the vehicle 2 that is traveling by a motor drive operation so as to make a person outside of the vehicle 2 notice the vehicle 2 approaching.

The vehicle presence notification apparatus 1 includes a modulating device 3 (or referred to as a modulating means or section) to modulate an ultrasonic wave functioning as a carrier wave according to an audible sound; a speaker 4 to generate a notice sound by emitting the modulated ultrasonic wave in the air; and an electronic control unit (ECU) 5 to execute an operation control of the modulating device 3 and the speaker 4.

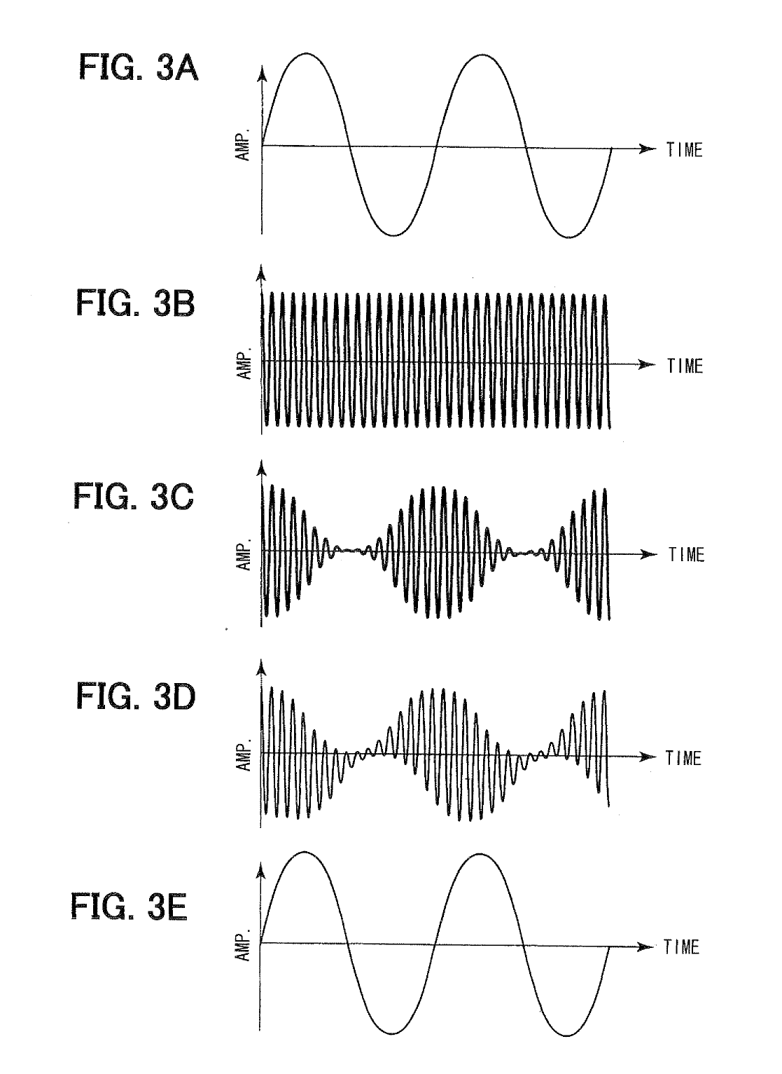

The ECU 5 may function as: an audible sound wave signal generating means or section to output a wave signal of an audible sound (called an audible sound wave signal, refer to FIG. 3A), which is desired to be reproduced; and an ultrasonic signal generating means or section to output an ultrasonic signal (refer to FIG. 3B), which is a carrier signal (or called a carrier wave signal).

The ECU 5 inputs an audible sound wave signal and an ultrasonic signal to a modulation/amplification circuit serving as the modulating device 3; the modulating device 3 modulates an amplitude of the ultrasonic signal according to the audible sound wave signal (refer to FIG. 3C). The modulation/amplification circuit includes a modulation circuit and an amplification circuit; in particular, the modulation circuit functions as the modulating device 3. The modulated ultrasonic wave signal causes a diaphragm 8 of the speaker 4 to vibrate; thereby the speaker 4 emits or outputs the modulated wave into the air.

As the modulated wave emitted into the air advances in the air, the waveform is distorted due to the nonlinear characteristic of the air (refer to FIG. 3D). The audible sound based on the original audible sound wave signal is demodulated (refer to FIG. 3E) to thus sounding the notice sound to make a pedestrian etc. to notice.

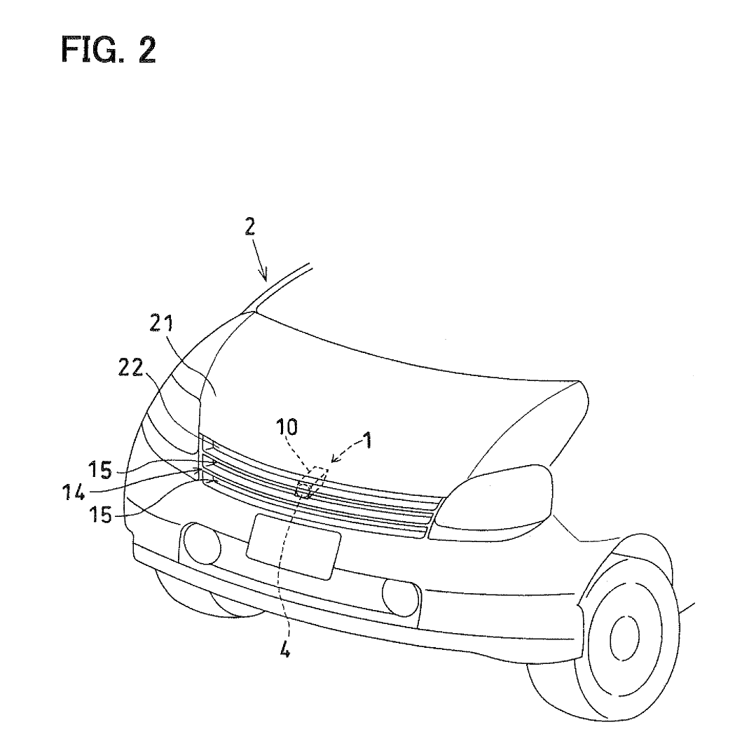

The speaker 4 is a corn type dynamic loudspeaker which emits a sound by vibrating the diaphragm 8 having a cone shape, for example. The speaker 4 is arranged to face the heading direction of the vehicle 2. In other words, the forward direction of the speaker 4 accords with the heading direction of the vehicle 2 (refer to FIGS. 1A to 1C, 2) such that the sound wave is emitted toward the heading direction of the vehicle 2 according with the forward direction of the speaker 4 during a duration for which the vehicle travels forward.

It is noted that the forward direction of the speaker 4 signifies a direction toward which the speaker 4 emits a sound wave. Further, the backward direction signifies the direction reverse to the forward direction while any direction other than the forward direction and backward direction is referred to as a sideward direction.

A porosity member 9, which is formed of Gore-Tex, is arranged in the forward direction of the speaker 4 (i.e., in front of the speaker 4). It is noted that Gore-Tex is a waterproof/breathable fabric and a registered trademark of W. L. Gore & Associates. The porosity member 9 is provided in such a size and at such a position that the front of the speaker 4 can be protected from the running wind, which advances against the front of the speaker 4. In addition, the speaker 4 is installed inside a housing 10. The forward direction of the speaker 4 is blocked by the porosity member 9, whereas directions other than the forward direction, for instance, the backward direction and a direction orthogonal to the forward direction of the speaker 4 (i.e., the sideward direction of the speaker 4) are closed by the housing 10.

In addition, a surrounding wall 11 which surrounds an advancing course of the sound wave is provided in the forward direction of the speaker 4. The speaker 4 is arranged such that the gap or space 15 in the front grille 14 of the vehicle 2 can be utilized as an advancing course of the sound wave (refer to FIG. 2). The front grille 14 serves as at least a part of the surrounding wall 11. The above-mentioned porosity member 9 may be fixed to adhere to an inner circumference of the surrounding wall 11 (refer to FIG. 1B). The porosity member 9 may be fixed to adhere so as to cover the forward direction of the surrounding wall 11 (refer to FIG. 1C).

### Effect of First Example

The vehicle presence notification apparatus 1 according to the present first example includes a modulating device 3 to modulate an ultrasonic wave functioning as a carrier wave according to an audible sound; and a speaker 4 to generate a notice sound by emitting the modulated ultrasonic wave in the air.

Under such a configuration, as proceeding in the air, the modulated ultrasonic wave is gradually demodulated to become an audible sound. The audible sound posterior to the demodulation has a significant directivity like the ultrasonic wave. Thus, the notice sound can be conveyed mainly to a pedestrian who is present in an area range where a danger needs to be taught.

Therefore, the sense of discomfort due to the notice sound can be reduced or relieved with respect to a pedestrian, who is not present in a dangerous place or a person who is inside of a vehicle compartment. In addition, by the help of directivity, a sound can be conveyed to the area range where the potential danger needs to be taught. Even a compact speaker 4 can thus properly function as reporting the presence of the subject vehicle 2.

In addition, the ultrasonic wave has a characteristic to relatively easily to attenuate; thus, the demodulated audible sound similarly easily attenuates. The notice sound does not reach a pedestrian or other vehicles which are separated distantly from the vehicle 2; thus, the notice sound may not be treated as useless noise.

In addition, the speaker 4 is provided so that the sound wave may be emitted toward the heading direction of the vehicle 2; the porosity member 9 is arranged in front of the speaker 4.

Under such a configuration, the porosity member 9 can help prevent the running wind from entering an inside of the speaker 4, without interrupting transmission of the sound wave, thereby protecting the speaker 4 from dusts in the running wind. In addition, the porosity member 9 is formed of Gore-Tex, which is a waterproof/breathable fabric and a registered trademark of W. L. Gore & Associates. Thus, the waterproofing effect can be improved, thereby helping prevent the permeation of the water to the speaker 4.

Further, in the vehicle presence notification apparatus 1 according to the present first example, the speaker 4 is installed inside of the housing 10; the forward direction (i.e., an area facing the front) of the speaker 4 is blocked by the porosity member; and directions other than the forward direction of the speaker 4 (i.e., sides other than the front side) are closed by the housing 10. Thus, the housing 10 closes directions other than the forward direction of the speaker 4, thereby preventing the flow of the air due to the running wind from passing through the speaker 4. Accordingly, without the influence of the running wind, the speaker 4 can be protected from the dust in the running wind.

In addition, the surrounding wall 11 which surrounds an advancing course of the sound wave is provided in the forward direction of the speaker 4. Under such a configuration, the surrounding wall 11 provides a function of a megaphone. Thereby, while the directivity is enhanced, the sound can be amplified, thus allowing the installation of the speaker 4 having a small output capability.

Furthermore, in the present first example, the speaker 4 is arranged using the space 15 in the front grille 14 of the vehicle 2. The front grille 14 serves as at least a part of the surrounding wall 11. The cost for installing the surrounding wall 11 can be thus reduced.

### Configuration of Second Example

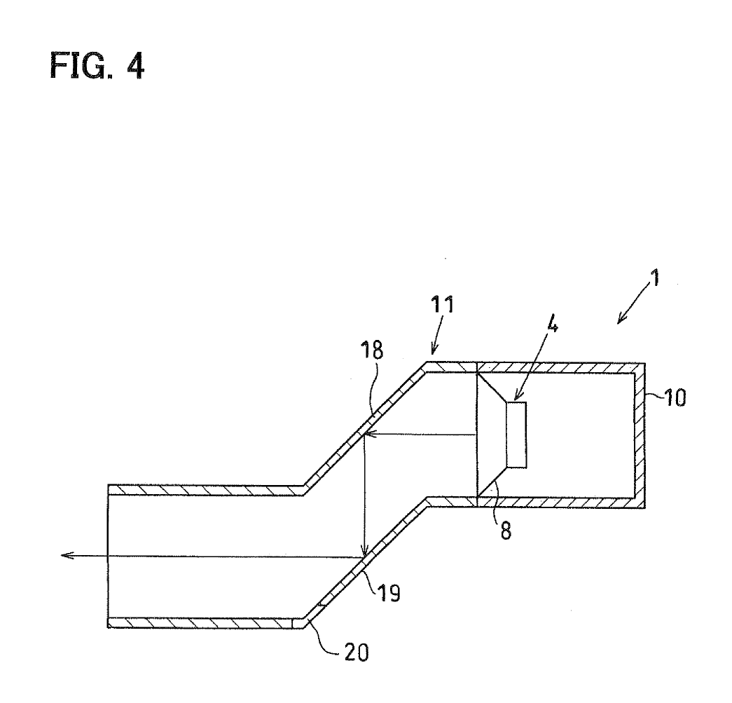

A configuration of a vehicle presence notification apparatus 1 according to a second example of the first embodiment is explained mainly with respect to a difference from the first example using FIG. 4. In the vehicle presence notification apparatus 1 according to the present second example, a reflector plate is provided for making bent the course of the sound wave from the speaker 4, thereby emitting the sound wave toward the heading direction of the vehicle 2.

In the present second example, a surrounding wall 11 arranged in the forward direction of the speaker 4 is shaped of a pipe which is bent. That is, the surrounding wall 11 has a first reflector plate 18 which has an inclination to allow a sound wave advancing straightly from the speaker 4 to be incident by an angle equal to or less than a critical angle (i.e., 45 degrees); and a second reflector plate 19 which has an inclination to allow a sound wave reflected by the reflector plate 18 to be incident by an angle equal to or less than a critical angle (i.e., 45 degrees). Accordingly, the sound wave emitted from the speaker 4 advances inside of the bent pipe via the first and second reflector plates 18, 19 and is then emitted toward the heading direction of the vehicle 2.

Under such a configuration, while the speaker 4 is arranged in the position where the running wind does not hit directly, the sound wave can be emitted toward the desired direction (i.e., heading direction of the vehicle) using the reflection of sounds. That is, without need of the coverage by the porosity member 9 or thin film, the front side of the speaker is not exposed directly against the running wind; thus, while the speaker 4 can be protected from the dust in the running wind, the sound wave can be emitted toward the heading direction of the vehicle 2.

In addition, an opening hole 20 to drain water or dust is provided in the second reflector plate 19, which directly collides with a running wind of the vehicle. It is noted that the opening hole 20 is for the water or dust and is arranged in a predetermined position with a predetermined size, so as not to prevent the reflection of the sound wave. Such a configuration can release, via the opening hole 20, the water or dust contained in the running wind; thereby, the dust in the running wind, etc. hits the second reflector plate 19, thereby being prevented from finally reaching the speaker 4.

### Modification Example

In the first example, the porosity member 9 is arranged in the forward direction or ahead of the speaker 4. In this regard, however, without need to be limited, a thin film 29 may be arranged in the forward direction of or ahead of the speaker 4. See FIG. 1C, where the porosity member 9 may be replaced by the thin film 29. The thin film 29 can convey a sound by vibrating; thus, the thin film 29 can similarly help prevent the running wind from entering an inside of the speaker 4, without interrupting transmission of the sound wave, thereby protecting the speaker 4 from dusts in the running wind. In addition, the thin film 29 may be formed of polyethylene terephthalate (PET) or polyethylenenaphthalate (PEN). It is because such a configuration can maintain a relatively high intensity even using a thin film, thus allowing manufacture to require comparatively low costs.

In the first example, the speaker 4 is arranged such that the gap or space 15 in the front grille 14 of the vehicle 2 can be utilized as an advancing course of the sound wave. In this regard, however, without need to be limited, the speaker 4 may be arranged in the space 22 between the front grille 14 and a hood 21 (refer to FIG. 1) of the vehicle 2; thus, both the front grille 14 and the hood 21 may be a part of the surrounding wall 11.

In addition, in the vehicle presence notification apparatus 1 according to the first and second examples, the housing 10 may be extended forward to thereby form a part of the surrounding wall 11.

In addition, in the first and second examples, the speaker 4 is explained as being a corn type dynamic loudspeaker. However, without need to be limited, the speaker 4 may be a piezoelectric type, a condenser type, etc.. In addition, in the first and second examples, a notice sound is explained as being a false engine sound or a false running sound, to make a person near the vehicle 2 recognize that the vehicle 2 approaches when the vehicle 2 is an electric vehicle or when the vehicle 2 is a hybrid vehicle using both the engine and the electric motor is traveling with the motor drive. However, the notice sound may be an alarm sound which reports the presence or existence of any type of a vehicle without need to be limited to the vehicle type such as an electric vehicle or a hybrid vehicle.

### 2. SECOND EMBODIMENT

According to a first aspect of a second embodiment of the present invention, a vehicle presence notification apparatus is to report an approach of a vehicle by a notice sound vibrating with a frequency in an audible region. Further, the vehicle presence notification apparatus includes a speaker to emit a notice sound into the air by putting the notice sound on a carrier wave which vibrates in a frequency of an ultrasonic range; and a carrier frequency switching section to switch the frequency of the carrier wave. The carrier frequency switching section stores a carrier frequency switching pattern for switching the frequency of the carrier wave among the several different values and switches the several values of the frequency of the carrier wave according to the carrier frequency switching pattern.

In addition, the carrier frequency switching pattern includes an interval to temporarily stop the generation of the carrier wave when switching the frequency of the carrier wave from one value to another value.

According to a vehicle presence notification apparatus of a second aspect of the second embodiment of the present invention, in the carrier frequency switching pattern, when the frequency of the carrier wave changes from one value to another value, the generation of the carrier wave continues without interruption.

A vehicle presence notification apparatus according to a third aspect of the second embodiment includes a notice sound frequency switching means or section to switch (values of) the frequency of the notice sound. The notice sound frequency switching means or section switches the frequencies (or values of the frequency) of the notice sound in conjunction with the switching of the frequencies (or values of the frequency) of the carrier wave.

### EXAMPLES

### Configuration of First Example

A configuration of a vehicle presence notification apparatus 101 according to a first example of the second embodiment is explained with reference to FIGS. 3A to 3E, 5, 6A to 6D, and 7A to 7C. A vehicle presence notification apparatus 101 is mounted in a subject vehicle driven by a motor such as an electric vehicle or hybrid vehicle, which may involve a risk that a pedestrian etc. may not notice the vehicle approaching because of the quietness resulting from the motor drive operation. For example, the notification of the vehicle approaching is made for a pedestrian ahead of the vehicle.

In the vehicle presence notification apparatus 101, a notice sound vibrating with a frequency in an audible range (refer to FIG. 3A) is put on a carrier wave vibrating with a frequency in an ultrasonic range (refer to FIG. 3B); thereby, the notice sound on the carrier wave is emitted into the air as an ultrasonic wave. This uses a principle of so-called “parametric speaker.” That is, the sound wave emitted from the vehicle presence notification apparatus 101 is an ultrasonic wave, which has undergone an amplitude modulation of a carrier wave based on a notice sound (refer to FIG. 3C). The vehicle presence notification apparatus 101 can thus demonstrate a significant directivity by using such an ultrasonic wave.

The ultrasonic wave emitted from the speaker of the vehicle presence notification apparatus 101 spreads in the air. While spreading in the air, the ultrasonic wave becomes distorted because of a nonlinear characteristic of the air (refer to FIG. 3D) and undergoes a self demodulation at a position depending on the value of the frequency of the carrier wave, thereby becoming a notice sound (refer to FIG. 3E). The nonlinear characteristic of the air signifies that the period required to be compressed is shorter (i.e., smaller) than the period required to be restored from the compressed state.

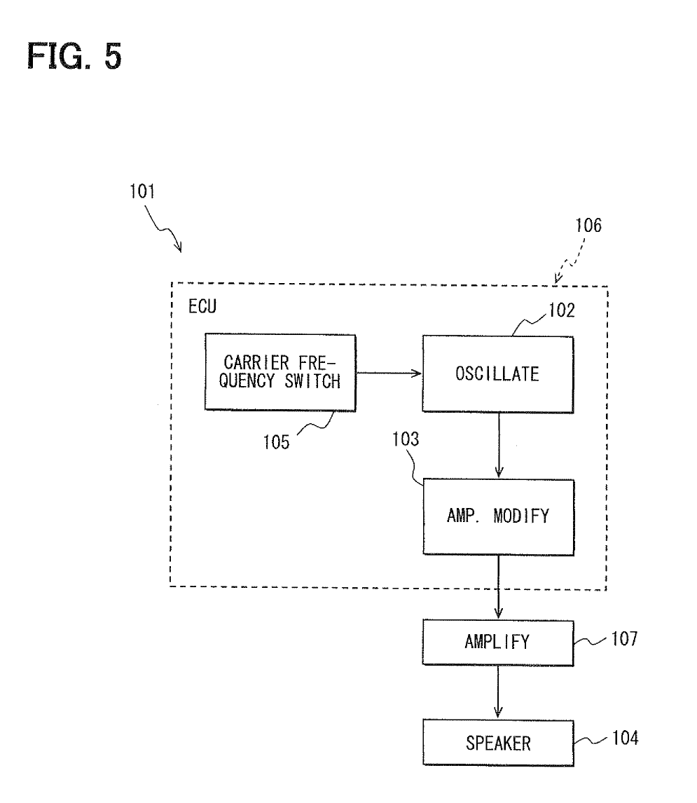

For instance, as shown in FIG. 5, the vehicle presence notification apparatus 101 includes the following: an oscillating means or section 102 to generate an electrical signal which vibrates with a frequency in an ultrasonic range; an amplitude modulating means or section 103 which carries out an amplitude modulation of the electrical signal generated by the oscillating section 102 based on the waveform of the notice sound; a speaker 104 which converts an electric signal, which is outputted from the amplitude modulating section 103, into a mechanical vibration, and emits into the air an ultrasonic wave on which a notice sound is put or overlapped (i.e., an ultrasonic wave obtained by modulating the carrier wave based on the notice sound, refer to FIG. 3C); and a carrier frequency switching means or section 105 to switch frequencies (i.e., values of the frequency) of the carrier wave.

It is noted that the oscillating section 102, amplitude modulating section 103, and carrier frequency switching section 105 are the functions included or assembled in the electronic control unit (ECU) 106 mounted in the subject vehicle, for example. Furthermore, the ECU 106 is configured to contain a known microcomputer having: a CPU having a control function and a computation function; various kinds of storage devices such as ROM and RAM; an input device; and an output device.

The oscillating means 102 is a voltage control transmitter which can vary the oscillation frequency depending on an applied voltage, for example. The electrical signal which vibrates with the frequency of the ultrasonic range, i.e., the electrical signal which vibrates with the frequency of the carrier wave, is generated. The generated electric signal undergoes the processing of waveform shaping etc. and is inputted to the amplitude modulating section 103.

The amplitude modulating section 103 is designed to carry out an amplitude modulation of the electrical signal outputted from the oscillating section 102, for example, based on the wave waveform of the notice sound. By using the functions of the oscillating section 102 and amplitude modulating section 103, the ECU 106 outputs the electrical signal, which has a frequency in an ultrasonic wave range and has undergone an amplitude modulation based on the sound waveform of the notice sound.

The speaker 104 generates the ultrasonic wave by this mechanical vibration while transforming into the mechanical vibration the electrical signal inputted into self. Furthermore, the electrical signal inputted into the speaker 104 is a signal which is obtained by amplifying the electrical signal outputted from ECU 106 using an amplifier 107. That is, in the amplifier 107, the electrical signal outputted from the ECU 106 is amplified to the extent so as to allow the speaker 104 to be driven.

The carrier frequency switching section 105 switches oscillation frequencies (i.e., value of the oscillating frequency) of the oscillating section 102, thereby switching the frequencies (i.e., the values of the frequency) of the carrier wave. Further, the carrier frequency switching section 105 stores a carrier frequency switching pattern for switching the carrier wave frequency among the several different values. The oscillating section 102 instructs the carrier frequency switching section 105 to switch the oscillating frequency according to the carrier frequency switching pattern. For example, the carrier frequency switching section 105 outputs a control signal to vary a voltage applied to the voltage control transmission section according to the carrier frequency switching pattern.

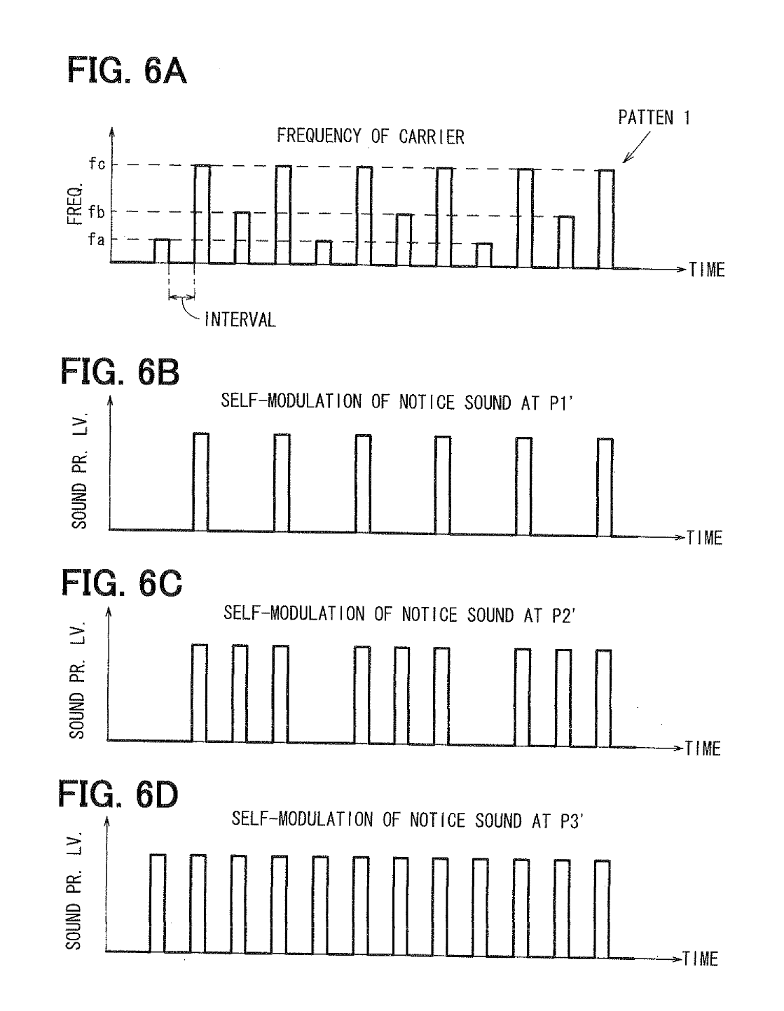

A carrier frequency switching pattern 1 of the first example is set up, for example, such that the frequency of the carrier wave changes among the different values fa, fb, and fc, as illustrated in FIG. 6A.

It is noted, for instance, in FIG. 6A, the whole of twelve pulses together with intervals is defined as corresponding to a notice sound carried by a carrier wave having a frequency having three different frequency values fa, fb, and fc. Furthermore, each pulse is defined as corresponding to a single notice sound element carried by a single carrier wave element having a frequency having a single frequency value. In other words, a notice sound includes several notice sound elements, each of which is carried by a carrier wave element having a frequency having a single frequency value. It is noted that the large and small relation of the values fa, fb, and fc is fa<fb<fc. In the pattern 1, the frequency is changed to repeat an order of fa−>fc−>fb−>fc; furthermore, an interval to temporarily interrupt the generation of the carrier wave is provided when the frequency is changed or switched from one value to another value.

The ultrasonic wave emitted from the speaker 104 undergoes the self demodulation to thereby be audible as a notice sound at a position. Such a position varies depending on the frequency (i.e., the value of the frequency) of the carrier wave. That is, as the frequency (i.e., the value of the frequency) of the carrier wave becomes smaller, the position of the self demodulation becomes more distant from the position of the speaker 104.

Therefore, when an ultrasonic wave or ultrasonic wave elements are emitted from the speaker 104 according to the pattern 1, the following takes place. As the distance from the speaker 104 becomes longer (i.e., greater), the notice sound elements included in the notice sound carried by the carrier wave elements undergo the self demodulation to thereby become audible one element by one element from an element having a higher frequency value to an element having a lower frequency value. For example, the notice sound elements undergo one element by one element the self demodulation at each of the positions P1′, P2′, and P3′ in the ascending order of the distance from the speaker 104, starting with the position P1′, via the position P2′, ending with the position P3′; thereby, all the notice sound elements (i.e., the whole of the notice sound) become audible finally at the position P3′, as illustrated in FIGS. 6B to 6D.

For instance, among the notice sound elements included in the notice sound, which is carried by the carrier wave element and emitted, the notice sound element carried by the carrier wave element with the frequency (value) fc undergoes the self demodulation at the position P1′ closest to the speaker 104 among the positions P1′ to P3′, thereby becoming audible (refer to FIG. 6B). Next, the notice sound element carried by the carrier wave element with the frequency (value) fb undergoes the self demodulation at the position P2′ in a middle position to the speaker 104 among the positions P1′ to P3′, thereby becoming audible (refer to FIG. 6C). Finally, the notice sound element carried by the carrier wave element with the frequency (value) fa undergoes the self demodulation at the position P3′ farthest from the speaker 104 among the positions P1′ to P3′, thereby becoming audible (refer to FIG. 6D).

Furthermore, the following is noted in case that the frequency of the carrier wave changes among several values, i.e., the frequencies having respective values of the carrier wave elements are switched therebetween. An ultrasonic wave element having a specific value of the frequency and carrying a notice sound element is to undergo self demodulation and become audible at a specific position, which is called a position of self demodulation. Such a position of self demodulation is thus varied depending on a value of the frequency of the carrier wave element of the ultrasonic wave element. Similarly, a position, at which an audible notice sound element is to attenuate and become inaudible, is varied depending on a value of the frequency of the carrier wave element. That is, a position, at which the sound pressures of the notice sound element falls below the audible level, is varied depending on a value of the frequency of the carrier wave element. As the value of the frequency of the carrier wave element becomes smaller, the position of self demodulation becomes more distant from the position of the speaker 104. As the value of the frequency of the carrier wave element becomes smaller, the position where the notice sound element becomes inaudible becomes more distant from the position of the speaker 104.

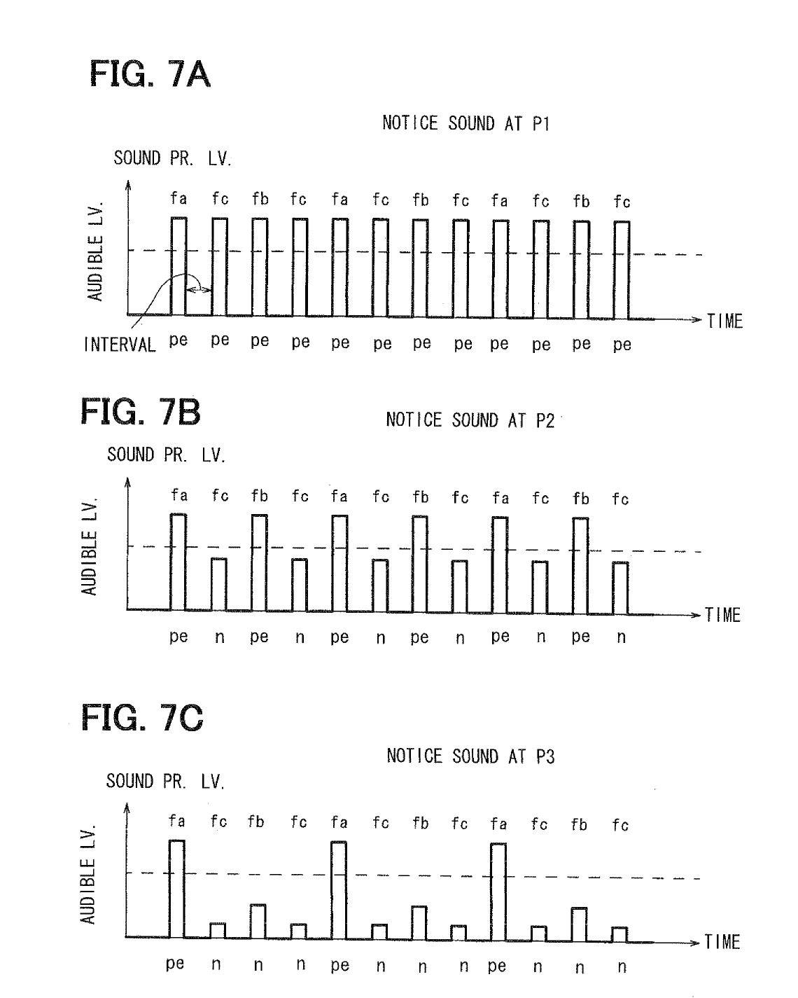

Accordingly, after all the ultrasonic wave elements emitted from the speaker 104 according to the pattern 1 undergo self demodulation and become the notice sound elements, the following take place. As the distance from the speaker 104 becomes longer, the notice sound elements attenuate to become inaudible one element by one element from a notice sound element carried by the carrier wave element having a higher frequency value to another notice sound element carried by the carrier wave element having a lower frequency value. For example, the notice sound elements attenuate to become inaudible one element by one element at the positions P1, P2, and P3, in the ascending order of the distance from the speaker 104, starting with the position P1, via the position P2, ending with the position P3, as illustrated in FIGS. 7A to 7C; thereafter, all the notice sound elements become inaudible finally. Furthermore, the position P1 in FIG. 7A is more distant from the speaker 104 than the position P3′ in FIG. 6D. At the position P1, the sound pressure levels of all the notice sound elements posterior to the self demodulation exceed the audible level, and all the notice sound elements are heard, i.e., audible (refer to FIG. 7A).

At the position P2 being a middle position, among the notice sound elements posterior to the self demodulation, the element carried by the carrier wave element having the frequency fc becomes inaudible (refer to FIG. 7B). Subsequently, at the position P3 farthest from the speaker 104, the element carried by the carrier wave element having the frequency fb becomes inaudible (refer to FIG. 7C). Thereafter, the element carried by the carrier wave element having the frequency fa becomes inaudible at a position farther than the position P3 from the speaker 104.

Now, the notice sound elements in FIG. 7A to 7C are heard as follows. The tone corresponding to one pulse of the notice sound element greater than the audible level shown in FIGS. 7A to 7C is represented by “pe” while the inaudible element corresponding to one pulse of the notice sound element less than the audible level is represented by “n”. At the position P1, the notice sound or notice sound elements are heard continuously such as “pe-pe-pe- . . . ” At the position P2, the notice sound or notice sound elements are heard with one-breath intervals such as “pe-n-pe-n-pe-n-pe . . . ” At the position P3, the notice sound or notice sound elements are heard with three-breath intervals such as “pe-n-n-n-pe-n-n-n-pe . . .” It is noted that in FIGS. 7A to 7C, the frequencies of the carrier wave elements are indicated above the pulses of the notice sound elements while the tones of the notice sound elements are indicated below the pulses.

When the vehicle approaches a pedestrian, for instance, the position relative to the vehicle of the pedestrian changes, in order, from the position P3−>position P2−>position P1. During the approaching, the vehicle continues emitting the ultrasonic wave by the vehicle presence notification apparatus 101. In such a case, the notice sound heard by the pedestrian changes “pe-n-n-n-pe-n-n-n-pe . . . ”−>“pe-n-pe-n-pe . . . ”−>“pe-pe-pe-pe . . . ”

### Effect of First Example

In the vehicle presence notification apparatus 101 according to the present first example, a notice sound is put on a carrier wave which vibrates with a frequency of an ultrasonic range, thereby being emitted as an ultrasonic wave in the air. The ECU 106 switches the frequency of the carrier wave according to the pattern 1 for the carrier frequency switching. In the pattern 1, the carrier frequency is switched among three values of fa, fb, fc in an order of fa−>fc−>fb−>fc, while such an order is repeated continuously. It is noted that the large and small relation of the three values is as follows: fa<fb<fc. Furthermore, an interval to temporarily interrupt the generation of the carrier wave is inserted when the values of the frequency are changed from one value to another value.

The ultrasonic wave emitted in the air undergoes the self demodulation, thereby generating a notice sound. As the distance from the speaker 104 becomes farther or longer, more portion of the notice sound attenuates to become inaudible sequentially; finally, any notice sound or any notice sound element becomes inaudible. Under the above operation, for instance, in cases that the vehicle approaches a pedestrian while emitting the ultrasonic wave via the vehicle presence notification apparatus 101, the notice sound or notice sound elements heard by the pedestrian change so that the intervals between the soundings of the notice sound, i.e., the intervals between the notice sound elements become shorter. This is illustrated in FIG. 7C to 7A as “pe-n-n-n-pe-n-n-n-pe . . . ” in FIG. 7C−>“pe-n-pe-n-pe-n-pe . . . ” in FIG. 7B−>“pe-pe-pe-pe-pe-pe . . . ” in FIG. 7A.

Under such a configuration, the pedestrian can hear the notice sound such that as the distance to the vehicle becomes closer, the interruption intervals of the sound generation (i.e., the interval between the notice sound elements) becomes shorter. Thus, a pedestrian or the like can recognize the sense of distance to the subject vehicle, irrespective of the sound pressure level in the back ground noise.

### Configuration of Second Example

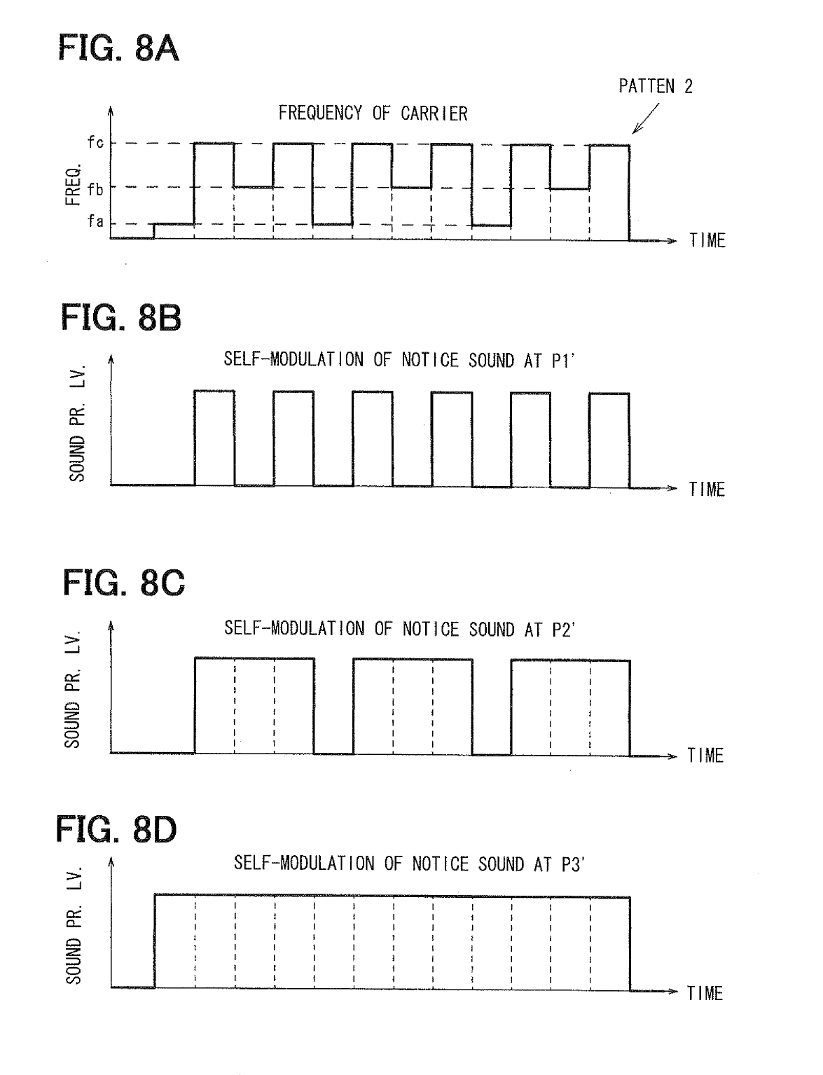

In a vehicle presence notification apparatus 101 according to a second example of the second embodiment, a carrier wave switching pattern is provided in which the generation of the carrier wave continues without any interruption when the frequency of the carrier wave changes from one value to another value. Refer to FIG. 8A, which illustrates a pattern 2 for the carrier frequency switching according to the present second example of the second embodiment.

For example, similarly to the pattern 1, in the pattern 2, the frequency is changed among three different values fa, fb, and fc in an order of fa−>fc−>fb−>fc while such an order is repeated in the generation of the ultrasonic wave. It is noted that the pattern 2 is different from the pattern 1 in that the generation of the carrier wave is continued without any interval that temporarily interrupts the generation of the carrier wave when the values of the frequency are changed from one value to another value.

Thus, when the ultrasonic wave is emitted from the speaker 104 according to the pattern 2, the self demodulation takes place, for instance, as illustrated in FIGS. 8B to 8D. The distance from the speaker 104 becomes longer in an order of P1′−>P2′−>P3′ one by one. As the distance becomes longer, more portion of the notice sound undergoes the self demodulation gradually (i.e., more of the notice sound elements undergo the self demodulation one by one in the ascending order of the distance from the speaker 104, starting with the position P1′, via the position P2′, ending with the position P3′); thereby, the whole of the notice sound (all the notice sound elements) becomes audible at the position P3′, as illustrated in FIG. 8D.

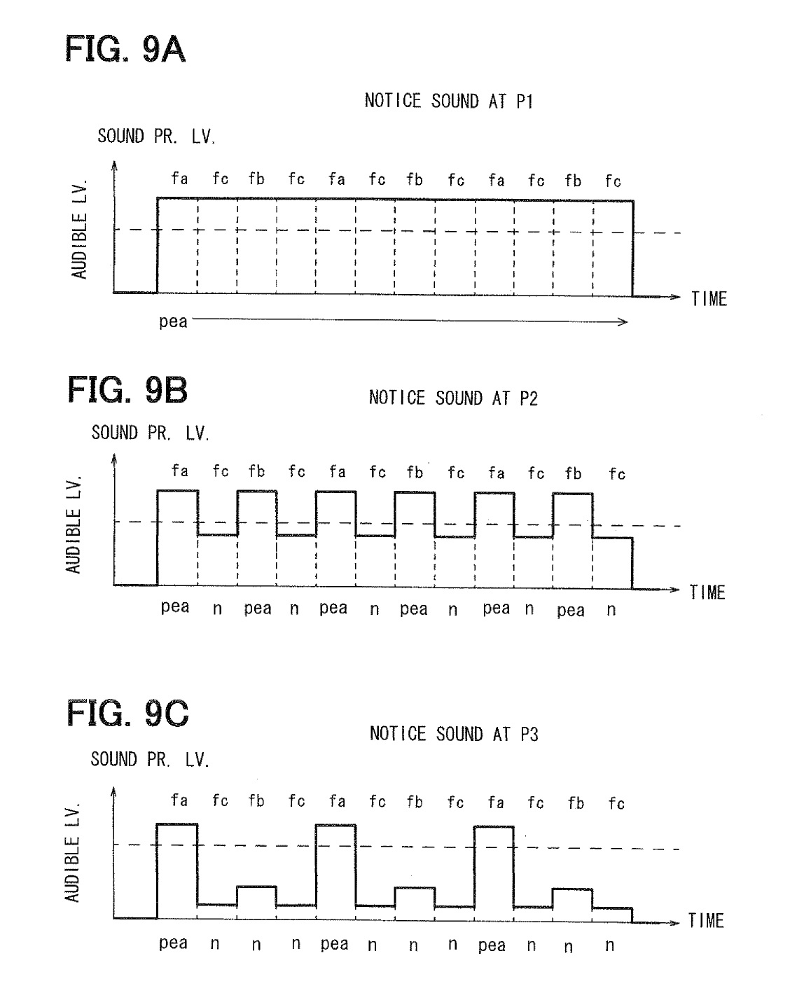

Further, after all the ultrasonic wave elements emitted from the speaker 104 according to the pattern 2 undergo the self demodulation to thereby become the notice sound or notice sound elements, the following takes place. For example, the notice sound or the notice sound elements attenuate to become inaudible one by one (one element by one element) in the ascending order of the distance from the speaker 104, starting with a position P1, via a position P2, ending with a position P3, as illustrated in FIGS. 9A to 9C; thereafter, all the notice sound elements become inaudible finally.

Now, the notice sound elements in FIG. 9A to 9C are heard as follows. The tone corresponding to one pulse of the notice sound element equal to or greater than the audible level shown in FIGS. 9A to 9C is represented by “pea” whereas the inaudible element corresponding to one pulse of the notice sound element less than the audible level is represented by “n”. At the position P1, the notice sound or all the notice sound elements can be heard such that “pea” is extended continuously. At the position P2, the notice sound is heard with one-breath intervals such as “pea-n-pea-n-pea-n-pea-n-pea-n-pea”. At the position P3, the notice sound is heard with three-breath intervals such as “pea-n-n-n-pea-n-n-n-pea-n-n-n”. It is noted that in FIGS. 9A to 9C, the frequencies of the carrier wave elements (i.e., values fa, fb, fc of the frequency of the carrier wave) are written above the pulses of the notice sound elements while the tones of the notice sound elements are written below the pulses.

Thus, in cases that the vehicle approaches a pedestrian while emitting the ultrasonic wave via the vehicle presence notification apparatus 101, the notice sound heard by the pedestrian changes like “pea-n-n-n-pea-n-n-n-pea-n-n-n”−>“pea-n-pea-n-pea-n-pea-n-pea-n-pea-n”−>“pea-pea- . . . ” Under such a configuration, the pedestrian can hear the notice sound such that as the distance to the vehicle becomes closer, the interruption intervals of the sound generation (i.e., the interval between the notice sound elements) becomes shorter. Thus, a pedestrian or the like can recognize the sense of distance to the subject vehicle approaching, irrespective of the sound pressure level in the back ground noise.

### Configuration of Third Example

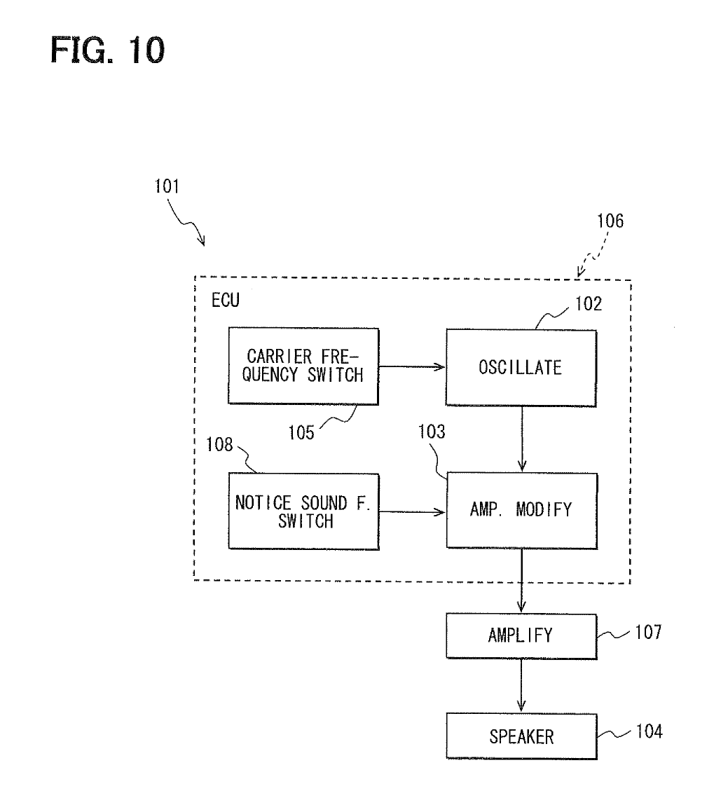

In a vehicle presence notification apparatus 101 according to the present third example of the second embodiment, as illustrated in FIG. 10, an ECU 106 includes a notice sound frequency switching section 108 (or called a means or a function) to switch frequencies of the notice sound (or to switch values of the frequency of the notice sound). The notice sound frequency switching section 108 switches the frequencies of the notice sound in conjunction with the switching of the frequencies of the carrier wave or wave elements. For example, the notice sound frequency switching section 108 instructs the amplitude modulating section 103 to switch the frequency of the notice sound in conjunction with an event that the carrier frequency switching section 105 instructs the oscillating section 102 to switch the frequency of the carrier wave.

It is noted that, for instance, the carrier frequency switching pattern 3 of the third example is comparable with the pattern 1 of the first example of the second embodiment. The notice sound frequency switching section 108 designates or sets up the values fx, fy, fx of the frequency of the notice sound with respect to the values fa, fb, fc of the frequency of the carrier wave, respectively. That is, the notice sound frequency switching section 108 functions as putting a notice sound element of the frequency value fx on a carrier wave element of the frequency value fa, putting a notice sound element of the frequency value fy on a carrier wave element of the frequency value fb, and putting a notice sound element of the frequency value fz on a carrier wave element of the frequency value fc.

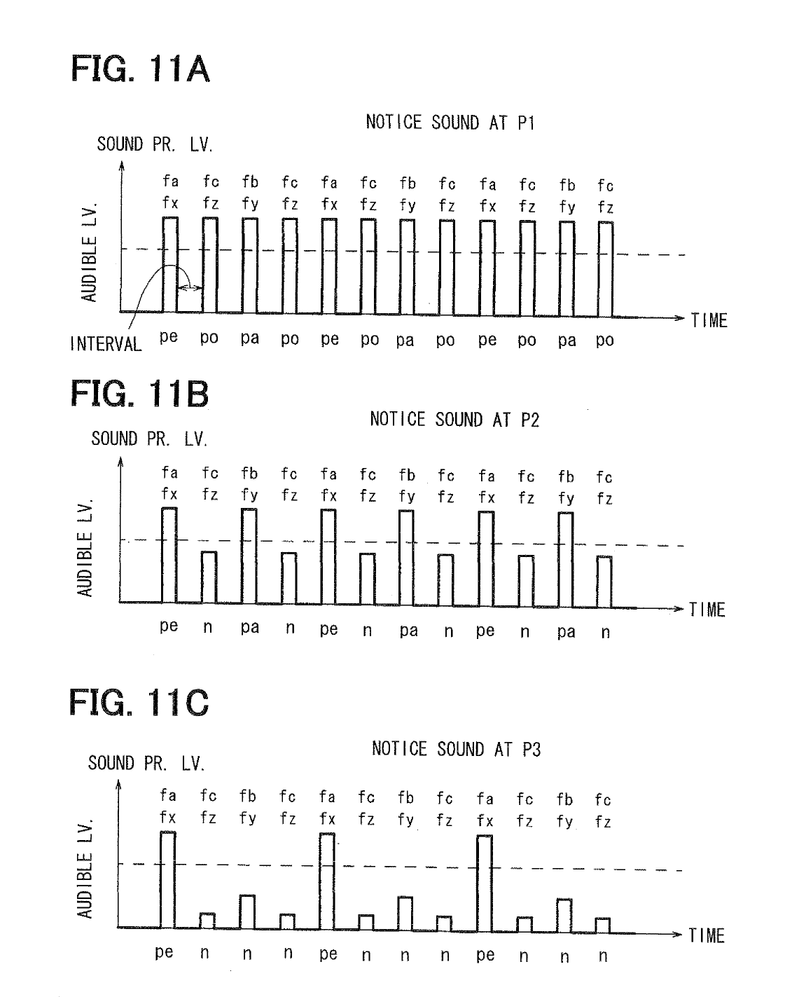

With respect to tones corresponding to each of the pulses of the notice sound elements equal to or greater than the audible level, the following is illustrated in FIGS. 11A to 11C. It is noted that the tone corresponding to the frequency value fx is represented by “pe”; the tone corresponding to the frequency value fy is represented by “pa”; the tone corresponding to the frequency value fz is represented by “po”; and the inaudible tone or portion corresponding to one pulse of the notice sound element less than the audible level is represented by “n”. At the position P1, the notice sound is heard such as “pe-po-pa-po-pe-po-pa-po-pe-po-pa-po”. At the position P2, the notice sound is heard with one-breath intervals such as “pe-n-pa-n-pe-n-pa-n-pe-n-pa-n”. Further, at the position P3, the notice sound is heard with three-breath intervals such as “pea-n-n-n-pea-n-n-n-pea-n-n-n”.

It is noted that in FIGS. 11A to 11C, the frequencies of the carrier wave elements (i.e., values fa, fb, fc of the frequency of the carrier wave) are written in an upper row above the pulses of the notice sound elements while the frequencies of the notice sound elements (i.e., values fx, fy, fz of the frequency of the notice sound) are written in a lower row above the pulses of the notice sound elements. In addition, the tones are written below the the pulses of the notice sound elements.

Thus, in cases that the vehicle approaches a pedestrian while emitting the ultrasonic wave via the vehicle presence notification apparatus 101, the notice sound heard by the pedestrian changes “pe-n-n-n-pe-n-n-n-pe-n-n-n” (in FIG. 11C)−>“pe-n-pa-n-pe-n-pa-n-pe-pa-n” (in FIG. 11B)−>“pe-po-pa-po-pe-po-pa-po-pe-po-pa-po” (in FIG. 11A). Under such a configuration, the pedestrian can hear the notice sound such that as the distance to the vehicle becomes closer, the interruption interval of the sound generation (i.e., the interval between the notice sound elements) becomes shorter. Thus, a pedestrian or the like can recognize the sense of distance to the subject vehicle approaching, irrespective of the sound pressure level in the back ground noise.

### Modification Example

In the vehicle presence notification apparatus 101 according to the above examples, the ECU 106 switches the frequency of the carrier wave among three values fa, fb, and fc. Without need to be limited, the frequency of the carrier wave may be switched among two values fd and fe, for example.

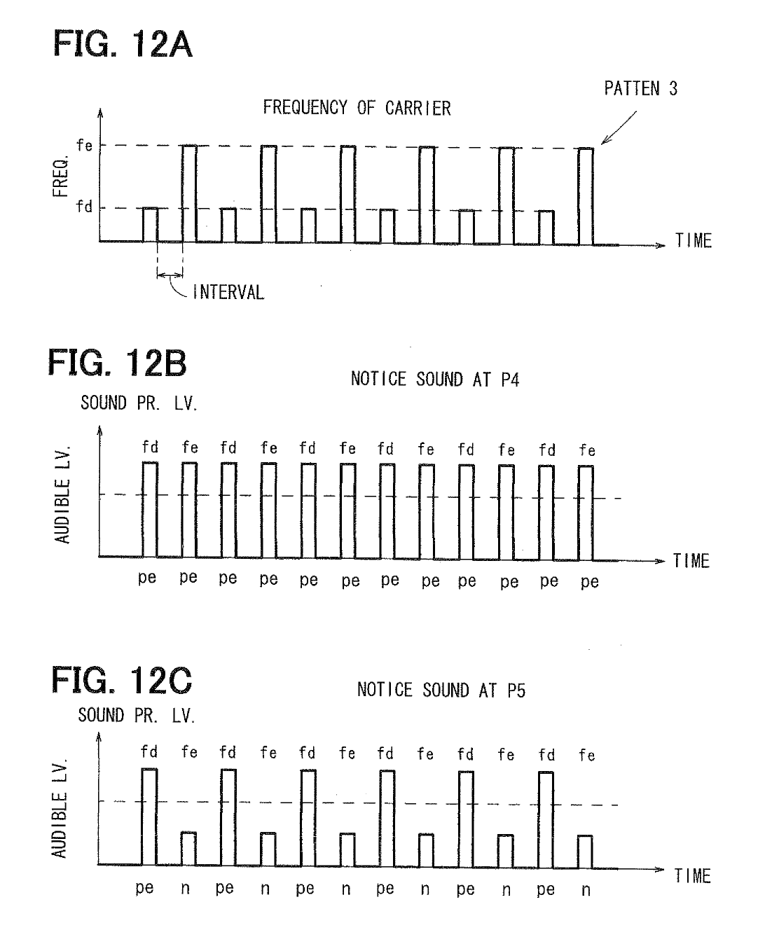

For instance, with reference to FIG. 12A, a pattern 3 may be provided such that the frequencies are switched repeatedly like fd−>fe−>fd−>fe−>. . . while an interval to temporarily interrupt the generation of the carrier wave is provided when the frequencies are changed from one value to another value. At the position P4, the notice sound is heard continuously such as “pe-pe-pe-pe-pe-pe . . . ”. At the position P5 farther than the position P4 from the speaker 104, the notice sound is heard with one-breath intervals such as “pe-n-pe-n-pe-n-pe-n-pe . . . ”. It is noted that in FIGS. 12B, 12C, the frequencies of the carrier wave elements (i.e., values fd, fe of the frequency of the carrier wave) are written above the pulses of the notice sound elements while the tones of the notice sound elements are written below the pulses.

Thus, in cases that the vehicle approaches a pedestrian while emitting the ultrasonic wave via the vehicle presence notification apparatus 101, the notice sound heard by the pedestrian changes “pe-n-pe-n-pe-n-pe-n . . . ” (in FIG. 12C)−>“pe-pe-pe-pe-pe . . . ” (in FIG. 12B). Thus, a pedestrian or the like can recognize the sense of distance to the subject vehicle approaching, irrespective of the sound pressure level in the back ground noise.

In addition, the frequency of the carrier wave may be switched among the values more than three. The frequency of the notice sound may be switched among two values or among values more than three. In addition, the carrier frequency switching pattern may include a switching portion to contain an interruption interval and a switching portion to not contain any interruption interval. Furthermore, it is not necessary that every value of the frequency of the carrier wave is assigned with a different value of the frequency of the notice sound element. For example, an example case is explained in which the frequency of the carrier wave is assigned with four values as follows. That is, two values of the frequency of the carrier wave may be assigned with an identical single value of the frequency of the notice sound element. In other words, the frequency of the carrier wave and the frequency of the notice sound or notice sound element can be designated in a variety of manners.

In the vehicle presence notification apparatus 101 according to the above examples, the ECU 106 includes the oscillating section 102, the amplitude modulating section 103, the carrier frequency switching section 105, and the notice sound frequency switching section 108. Without need to be limited, any apparatus unlimited to the manner in the above examples, i.e., ECU 106, may be alternatively provided so as to include the functions of the oscillating section 102, the amplitude modulating section 103, the carrier frequency switching section 105, and the notice sound frequency switching section 108.

Furthermore, in the vehicle presence notification apparatus 101 according to the above examples, the carrier frequency switching section 105 is designed to instruct the oscillating section 102 to switch the frequency of the carrier wave; the notice sound frequency switching section 108 is designed to instruct the amplitude modulating section 103 to switch the frequency of the notice sound or notice sound elements. Without need to be limited, a manner to switch the frequency of the carrier wave and a manner to switch the frequency of the notice sound or notice sound element may be alternatively designed.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a computer-readable storage media or can be downloaded and installed in a computer via a communications network.

Aspects of the disclosure described herein are set out in the following clauses.

As a first aspect of the disclosure, a vehicle presence notification apparatus for reporting a presence of a vehicle to an outside of the vehicle is provided as follows. A modulating section is configured to use an ultrasonic wave as a carrier wave and modulate the ultrasonic wave depending on an audible sound. A speaker is configured to emit the modulated ultrasonic wave in air, thereby producing the audible sound as a notice sound.

As an optional aspect of the vehicle presence notification apparatus, the speaker may be arranged so as to emit a sound wave including the ultrasonic wave toward a forward direction of the speaker while a porosity member or a thin film is arranged in the forward direction of the speaker; and the forward direction may accord with a heading direction of the vehicle. Under such a configuration, the porosity member or thin film can help prevent the running wind from entering an inside of the speaker, without interrupting transmission of the sound wave, thereby protecting the speaker from dusts in the running wind.

As an optional aspect of he vehicle presence notification apparatus, the speaker may be arranged inside of a housing; the forward direction of the speaker may be sealed by the porosity member or the thin film; and a direction other than the forward direction of the speaker may be closed by the housing. Such a configuration closes any direction other than the forward direction of the speaker, thereby preventing the flow of the air due to the running wind from passing through the speaker. Accordingly, without the influence of the running wind, the speaker can be protected from the dust in the running wind.

As an optional aspect of the vehicle presence notification apparatus, the porosity member may be formed of a material of Gore-Tex. Such a configuration can improve the waterproofing effect, thereby helping prevent the permeation of the water to the speaker.

As an optional aspect of he vehicle presence notification apparatus, the thin film may be formed of a material of a polyethylene terephthalate (PET) or a polyethylenenaphthalate (PEN). Such a configuration can maintain a relatively high intensity even using a thin film, thus allowing manufacture to require comparatively lower costs.

As an optional aspect of he vehicle presence notification apparatus, a reflector plate may be provided to make bent a course of a sound wave including the ultrasonic wave emitted from the speaker so as to emit the sound wave toward a heading direction of the vehicle. Under such a configuration, while the speaker is arranged in the position where the running wind does not hit directly, the sound wave can be emitted toward the desired direction using the reflection of sounds. That is, without need of the coverage by the porosity member or the thin film, the front of the speaker is not exposed directly against the running wind; thus, while the speaker can be protected from the dust in the running wind, the sound wave can be emitted toward the heading direction of the vehicle.

As an optional aspect of he vehicle presence notification apparatus, the reflector plate may be arranged to collide with a running wind of the vehicle; and an opening hole may be provided in the reflector plate so as to drain water and dust. Such a configuration can release the water or dust, which is contained in the running wind, via the opening hole while preventing the dust in the running wind, etc. from directly colliding with the speaker since the dust hits the reflector plate. It is noted that the opening hole is for the water or dust and is arranged in a predetermined position with a predetermined sized hole, so as not to prevent the reflection of the sound wave.

As an optional aspect of he vehicle presence notification apparatus, a surrounding wall may be provided in a forward direction of the speaker so as to surround a course of a sound wave including the ultrasonic wave emitted from the speaker. Such a surrounding wall can have an effect of a megaphone, thus enhancing the directivity more. Further, the sound can be amplified, thus allowing the use of a speaker having a small output capability in the above use.

As an optional aspect of he vehicle presence notification apparatus, the speaker may be arranged using a space in a front grille of the vehicle, or a space between a front grille and a hood of the vehicle; and the front grille or both the front grille and the hood may be included in the surrounding wall. Under such a configuration, the front grille or hood can be used as a part of the surrounding wall, decreasing the cost.

Furthermore, a second object of the present invention is to provide a vehicle presence notification apparatus which can allow a pedestrian or the like to understand the sense of distance to a subject vehicle, irrespective of sound pressure levels in back ground noises.

According to a second aspect of the disclosure, a vehicle presence notification apparatus for reporting an approach of a vehicle by a notice sound vibrating with a frequency of an audible region is provided as follows. A speaker is configured to put the notice sound on a carrier wave, which vibrates with a frequency of an ultrasonic range, to thereby emit in the air. A carrier frequency switching section is configured to switch the frequency of the carrier wave. The carrier frequency switching section is further configured to (i) store a carrier frequency switching pattern for switching the frequency of the carrier wave among several different frequency values and (ii) switch the frequency of the carrier wave depending on the stored carrier frequency switching pattern.

As an optional aspect of the vehicle presence notification apparatus, the carrier frequency switching pattern may be provided to include an interval to temporarily interrupt generation of the carrier wave when the frequency of the carrier wave is switched from one frequency value to an other frequency value among the several frequency values. At the position where, among the whole of the notice sound, the notice sound element carried by the carrier wave element with the frequency having the one value and the notice sound element carried by the carrier wave element with the frequency having the other value (both are referred to as targeted notice sound elements) are audible, both the notice sound elements are interrupted during the above interval to thereby be inaudible. Accordingly, the variation for making a pedestrian etc. understand the sense of distance to the vehicle may be made.

As an optional aspect of the vehicle presence notification apparatus, the carrier frequency switching pattern may be provided to continue generation of the carrier wave without any interval to interrupt the generation of the carrier wave when the frequency of the carrier wave is switched from one frequency value to an other frequency value among the several frequency values. At the position where, among the whole of the notice sound, both the above targeted notice sound elements are audible without any interruption interval therebetween. Accordingly, the variation for making a pedestrian etc. understand the sense of distance to the vehicle may be made.

As an optional aspect, the vehicle presence notification apparatus may further comprise a notice sound frequency switching section configured to switch the frequency of the notice sound. Herein, the notice sound frequency switching section may be further configured to switch the frequency of the notice sound in conjunction with the switching of the frequency of the carrier wave. Under such a configuration, at the position where, among the whole of the notice sound, the targeted notice sound element is audible, the switching of the tones can be recognized. Accordingly, the variation for making a pedestrian etc, understand the sense of distance to the vehicle can be increased.

It will be obvious to those skilled in the art that various changes may be made in the above-described embodiments of the present invention. However, the scope of the present invention should be determined by the following claims.

What is claimed:

1. A vehicle presence notification apparatus for reporting a presence of a vehicle to an outside of the vehicle, the apparatus comprising:
a modulating section configured to use an ultrasonic wave as a carrier wave and modulate the ultrasonic wave depending on an audible sound; and
a speaker configured to emit the modulated ultrasonic wave in air, thereby producing the audible sound as a notice sound.

2. The vehicle presence notification apparatus according to claim 1, wherein:
the speaker is arranged so as to emit a sound wave including the ultrasonic wave toward a forward direction of the speaker while a porosity member or a thin film is arranged in the forward direction of the speaker; and
the forward direction accords with a heading direction of the vehicle.

3. The vehicle presence notification apparatus according to claim 2, wherein:
the speaker is arranged inside of a housing;
the forward direction of the speaker is sealed by the porosity member or the thin film; and
a direction other than the forward direction of the speaker is closed by the housing.

4. The vehicle presence notification apparatus according to claim 2, wherein the porosity member is formed of a material of Gore-Tex.

5. The vehicle presence notification apparatus according to claim 2, wherein the thin film is formed of a material of a polyethylene terephthalate (PET) or a polyethylenenaphthalate (PEN).

6. The vehicle presence notification apparatus according to claim 1, wherein a reflector plate is provided to make bent a course of a sound wave including the ultrasonic wave emitted from the speaker so as to emit the sound wave toward a heading direction of the vehicle.

7. The vehicle presence notification apparatus according to claim 6, wherein:
the reflector plate is arranged to collide with a running wind of the vehicle; and
an opening hole is provided in the reflector plate so as to drain water and dust.

8. The vehicle presence notification apparatus according to claim 1, wherein a surrounding wall is provided in a forward direction of the speaker so as to surround a course of a sound wave including the ultrasonic wave emitted from the speaker.

9. The vehicle presence notification apparatus according to claim 8, wherein:
the speaker is arranged using a space in a front grille of the vehicle, or a space between a front grille and a hood of the vehicle; and
the front grille or both the front grille and the hood are included in the surrounding wall.

10. The vehicle presence notification apparatus according to claim 1, further comprising:
a carrier frequency switching section configured to switch a frequency of the carrier wave, wherein
the carrier frequency switching section is further configured to
store a carrier frequency switching pattern for switching the frequency of the carrier wave among several different frequency values and
switch the frequency of the carrier wave depending on the stored carrier frequency switching pattern.

11. The vehicle presence notification apparatus according to claim 10, wherein the carrier frequency switching pattern is provided to include an interval to temporarily interrupt generation of the carrier wave when the frequency of the carrier wave is switched from one frequency value to an other frequency value among the several frequency values.

12. The vehicle presence notification apparatus according to claim 10, wherein the carrier frequency switching pattern is provided to continue generation of the carrier wave without any interval to interrupt the generation of the carrier wave when the frequency of the carrier wave is switched from one frequency value to an other frequency value among the several frequency values.

13. The vehicle presence notification apparatus according to claim 10, further comprising:
a notice sound frequency switching section configured to switch a frequency of the notice sound,
wherein the notice sound frequency switching section is further configured to switch the frequency of the notice sound in conjunction with the switching of the frequency of the carrier wave.

14. A vehicle presence notification apparatus for reporting an approach of a vehicle by a notice sound vibrating with a frequency of an audible region,
the apparatus comprising:
a speaker configured to put the notice sound on a carrier wave, which vibrates with a frequency of an ultrasonic range, to thereby emit in the air; and
a carrier frequency switching section configured to switch the frequency of the carrier wave, wherein
the carrier frequency switching section is further configured to
store a carrier frequency switching pattern for switching the frequency of the carrier wave among several different frequency values and
switch the frequency of the carrier wave depending on the stored carrier frequency switching pattern.

15. The vehicle presence notification apparatus according to claim 14, wherein the carrier frequency switching pattern is provided to include an interval to temporarily interrupt generation of the carrier wave when the frequency of the carrier wave is switched from one frequency value to an other frequency value among the several frequency values.

16. The vehicle presence notification apparatus according to claim 14, wherein the carrier frequency switching pattern is provided to continue generation of the carrier wave without any interval to interrupt the generation of the carrier wave when the frequency of the carrier wave is switched from one frequency value to an other frequency value among the several frequency values.

17. The vehicle presence notification apparatus according to claim 14, further comprising:
a notice sound frequency switching section configured to switch the frequency of the notice sound,
wherein the notice sound frequency switching section is further configured to switch the frequency of the notice sound in conjunction with the switching of the frequency of the carrier wave.
